(19) United States
(12) Patent Application Publication
(10) Pub. No.: US 2013/0248095 A1
(43) Pub. Date: Sep. 26, 2013

(54) DECORATION FILM, METHOD OF FABRICATING A DECORATION FILM, AND METHOD OF FABRICATING A DECORATION DEVICE

(71) Applicants: Jen-En Hou, Taoyuan County (TW); Jin-Jung Yeh, Taoyuan County (TW); Shih-Min Huang, Taipei City (TW)

(72) Inventors: Jen-En Hou, Taoyuan County (TW); Jin-Jung Yeh, Taoyuan County (TW); Shih-Min Huang, Taipei City (TW)

(73) Assignee: ETANSI INC., Taoyuan County (TW)

(21) Appl. No.: 13/425,428

(22) Filed: Mar. 21, 2012

(51) Int. Cl. B32B 38/10; B32B 3/14; B05D 5/00; B05D 3/12; B05D 3/06; B05D 5/10

(52) U.S. Cl. 156/240; 427/558; 427/207.1; 427/264; 427/270; 427/277; 428/195.1; 428/201

(57) ABSTRACT

A decoration film, a method of fabricating a decoration film, and a method of fabricating a decoration device are provided. The decoration film includes a substrate and a relief pattern layer disposed on the substrate. The relief pattern layer has a relief surface away from the substrate and includes a decoration relief portion and a marker relief portion located around the decoration relief portion, wherein the relief pattern layer is remained on the substrate after the decoration process.

### BACKGROUND OF THE INVENTION

1. Field of the Invention

The present invention generally relates to a decoration film, a method of fabricating a decoration film, and a method of fabricating a decoration device, in particular, to a decoration film having a relief surface and fabricating by an embossing process, a method of fabricating a decoration film having a relief surface, and a method of fabricating a decoration device by using a decoration film having a relief surface.

2. Description of Related Art

The illustrations or decorations formed on the surface of the plastic or the metal housing can be fabricated by a decoration process using a decoration film which has predetermined decoration layers formed on the substrate. Conventionally, the process for decorating a metal housing is performed after the metal housing is stamped to have a predetermined shape. The decoration processes include an in-mold decoration (IMD) technique, a heat transfer printing process, a sublimation heat transfer process, a hot stamping process, an ink-jet printing process, a water transfer printing process, and the like.

For example, the process of the IMD technique includes placing the decoration film into a mold of the injection machine, injecting a melted resin or plastic material at a side of the decoration film in the mold so that the melted resin and the decoration layers of the decoration film are combined to form a decoration device, and thereafter ejecting the decoration device from the mold. Accordingly, the in-mold decoration process is completed.

With the variety of the requirements on the decoration device, the predetermined decoration layers must have various properties such as specific sense of touch. For example, the decoration device may be required to provide a relief outer surface such that a user can feel the roughness of the decoration device when touching thereon. Particularly, the portion capable of providing the roughness feeling in the decoration device can be further requested to be aligned to the illustration patterns formed on the decoration device. However, the portion capable of providing the roughness feeling in the decoration device and the illustration patterns are formed in different layers so that the alignment between the illustration patterns and the portion capable of providing the roughness feeling in the decoration device may be difficult.

### SUMMARY OF THE INVENTION

Accordingly, the present invention is directed to a decoration film having relief pattern layer with a relief marker for position alignment.

The present invention is directed to a method for fabricating a decoration film having relief pattern layer with a relief marker for position alignment.

The present invention is directed to a method for fabricating a decoration device having relief pattern on the outer surface thereof and the method uses a decoration film having a relief pattern layer with a relief marker for position alignment.

The present invention is directed to a decoration film for in-mold decoration process. The decoration film includes a substrate and a relief pattern layer disposed on the substrate. The relief pattern layer has a relief surface away from the substrate and includes a decoration relief portion and a marker relief portion located around the decoration relief portion, wherein the relief pattern layer is remained on the substrate after the in-mold decoration process.

According to an embodiment of the present invention, a material of the relief pattern layer comprises a rapid-cured material. For example, the rapid-cured material includes a UV-curable gum suitable for being cured immediately during an embossing process. The material of the relief pattern layer can further includes a dye, a pigment, a filler, or a combination thereof.

According to an embodiment of the present invention, the decoration film further includes a hard coat layer disposed on the relief surface of the relief pattern layer, wherein the hard coat layer has a decoration relief and a marker relief respectively corresponding to the decoration relief portion and the marker relief portion. The decoration relief and the marker relief are substantially conformed to the decoration relief portion and the marker relief portion, respectively. In an alternate example, a space is defined between the hard coat layer and a part of the decoration relief portion such that the decoration relief is substantially conformed to the other part of the decoration relief portion. Furthermore, the decoration film further includes an adhesion layer disposed on the hard coat layer away from the relief pattern layer. Alternately, the decoration film further includes a function layer disposed between the hard coat layer and the adhesion layer, wherein the function layer can include an ink layer, a metal layer, or a combination thereof. The decoration film can further include a releasing layer disposed between the hard coat layer and the relief pattern layer.

According to an embodiment of the present invention, a relief depth of the marker relief portion in the relief pattern layer is from 3 μm to 25 μm.

The present invention is further directed to a method for fabricating a decoration film. A rapid-cured material is applied on a substrate. An embossing process is performed on the rapid-cured material and the rapid-cured material is immediately cured to form a relief pattern layer having a relief surface away from the substrate, wherein the relief pattern layer can include a decoration relief portion and a marker relief portion located around the decoration relief portion.

According to an embodiment of the present invention, the rapid-cured material comprises a UV-curable gum.

According to an embodiment of the present invention, the method for fabricating a decoration film further includes forming a hard coat layer on the relief surface of the relief pattern layer, wherein the hard coat layer has a decoration relief and a marker relief respectively corresponding to the decoration relief portion and the marker relief portion.

According to an embodiment of the present invention, the decoration relief and the marker relief are substantially conformed to the decoration relief portion and the marker relief portion, respectively.

According to an embodiment of the present invention, the method of forming the hard coat layer includes applying a hard coat material on the relief pattern layer; adjusting an amount of the hard coat material on the relief pattern layer such that a space is defined between the hard coat material and a part of the decoration relief portion; and curing the hard coat material such that the decoration relief of the hard coat layer is substantially conformed to the other part of the decoration relief portion. In an example, the method for fabricating a decoration film further includes forming an adhesion layer on the hard coat layer away from the relief pattern layer. The method for fabricating a decoration film can further include forming a function layer disposed between the hard coat layer and the adhesion layer, wherein the function layer comprises an ink layer, a metal layer, or a combination thereof. In another example, the method for fabricating a decoration film can further include forming a releasing layer disposed between the hard coat layer and the relief pattern layer.

The present invention is also directed to a method for fabricating a decoration device. A decoration film is provided and the decoration film includes a substrate, a relief pattern layer, a hard coat layer, and an adhesion layer. The relief pattern layer is disposed on the substrate and has a relief surface away from the substrate. The relief layer includes a decoration relief portion and a marker relief portion located around the decoration relief portion. The hard coat layer is disposed on the relief surface of the relief pattern layer, wherein the hard coat layer has a decoration relief and a marker relief respectively corresponding to the decoration relief portion and the marker relief portion. The adhesion layer is disposed on the hard coat layer away from the relief pattern layer. Subsequently, the decoration film is adhered on a body and the substrate and the relief pattern layer are subsequently removed from the body to form a decoration device, wherein the relief pattern layer is remained on the substrate and the hard coat layer is exposed.

According to an embodiment of the present invention, the method of adhering the decoration film on the body comprises an in-mold decoration process.

According to an embodiment of the present invention, the decoration film further includes a releasing layer between the hard coat layer and the relief pattern layer, and the releasing is further removed during removing the substrate and the relief pattern layer from the body.

In light of the foregoing descriptions, in the decoration film according to an embodiment of the invention, the relief pattern layer formed on the substrate is fabricated by an embossing process and includes both a decoration relief portion and a marker decoration portion. Accordingly, the relief pattern layer on the substrate can be properly aligned to the pattern of the decoration layers subsequently formed on the substrate. The decoration device fabricated by the decoration film can provide certain roughness touching feeling at a part of the outer surface corresponding to the pattern and complies with the requirement of the user.

In order to make the aforementioned and other features and advantages of the invention more comprehensible, embodiments accompanying figures are described in detail below.

Herein, the same or similar reference numbers used in the drawings and the descriptions are referred as the same or similar elements. For clearly describing the concept of the invention, the shapes and the thickness of the elements in the embodiments accompanying with the drawings may not definitely comply with the real circumstance. In addition, the following descriptions are directed to the elements or the combinations thereof, but the elements are not particularly restricted in the contents or the descriptions. Any form or shape known by one skilled in the art is applicable in the invention. Moreover, the description that a material layer disposed on a substrate or disposed on another material layer means that the material layer is directly located on the substrate or the another material layer, and may also mean that some interlayer is interrupted between the material layer and the substrate or between the material layer and the another material layer.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 schematically shows a method for fabricating a decoration film according to an embodiment of the present invention.

FIG. 2 schematically illustrates a decoration film according to the present invention.

FIG. 3 is a cross-sectional view of the decoration film of FIG. 1 taking along line I-I′.

FIG. 4 schematically illustrates a decoration film according to a first embodiment of the present invention.

FIG. 5 schematically illustrates a decoration device fabricated by using the decoration film of FIG. 4 according to the first embodiment of the present invention.

FIG. 6 schematically illustrates a decoration film according to a second embodiment of the present invention.

FIG. 7 schematically illustrates a decoration device fabricated by using the decoration film of FIG. 6 according to the second embodiment of the present invention.

FIG. 8 schematically illustrates a decoration film according to a third embodiment of the present invention.

FIG. 9 schematically illustrates a decoration device fabricated by using the decoration film of FIG. 8 according to the third embodiment of the present invention.

FIG. 10 schematically illustrates a decoration film according to a fourth embodiment of the present invention.

FIG. 11 schematically illustrates a pattern roll using in the embossing process according to another embodiment of the invention.

FIG. 12 schematically illustrates a decoration film fabricated by the pattern roll of FIG. 11.

FIG. 13 schematically illustrates a decoration film fabricated by using the pattern roll 10A of FIG. 11.

### DESCRIPTION OF THE EMBODIMENTS

Reference will now be made in detail to the present embodiments of the invention, examples of which are illustrated in the accompanying drawings. Wherever possible, the same reference numbers are used in the drawings and the description to refer to the same or like parts.

For achieving a required touching feeling in a decoration device, the following descriptions exemplified depict a decoration film and the application thereof. Several decoration processes such as an in-mold decoration (IMD) technique, a heat transfer printing process, a sublimation heat transfer process, a hot stamping process, an ink-jet printing process, a water transfer printing process, and the like are provided for forming the decoration device, wherein the IMD technique substantially includes an in-mold labelling (IML) process, an in-mold film (IMF) process, an in-mold roller (IMR) process, or the like. It is noted that the decoration film described hereinafter can be applied in any of the aforesaid decoration processes, but the invention is not limited thereto.

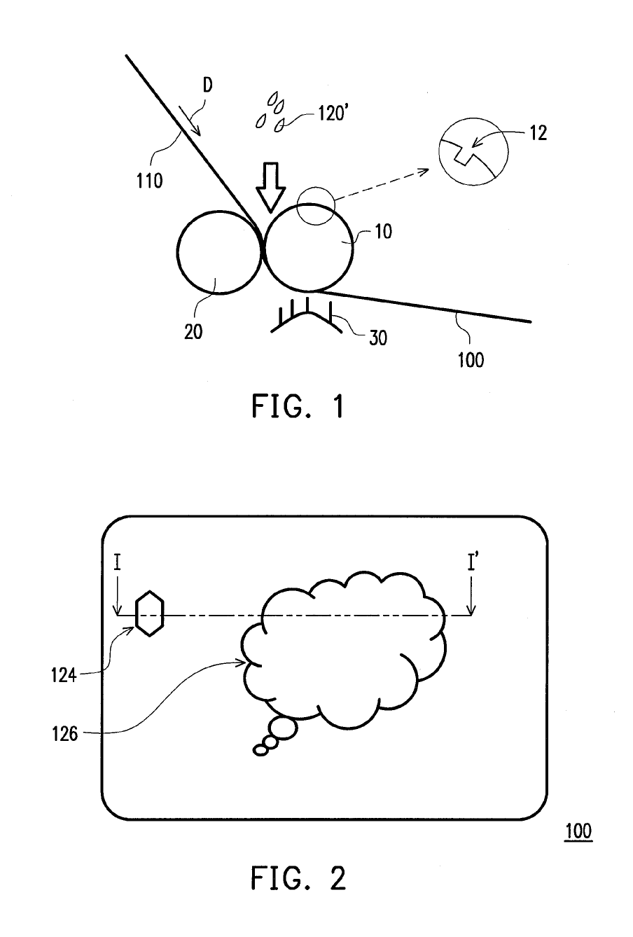

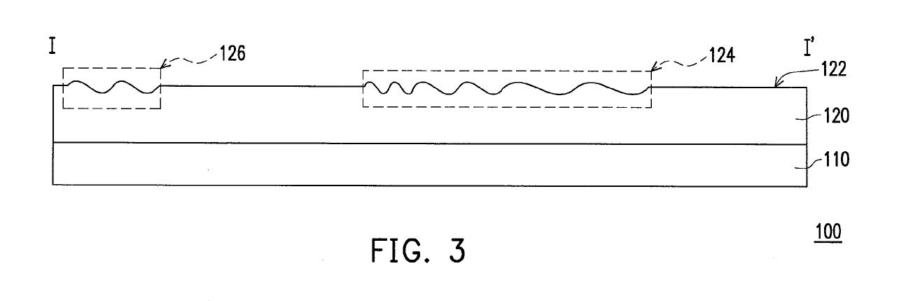

FIG. 1 schematically shows a method for fabricating a decoration film according to an embodiment of the present invention, FIG. 2 schematically illustrates a decoration film according to the present invention, and FIG. 3 is a cross-sectional view of the decoration film of FIG. 1 taking along line IT. Referring to FIGS. 1 to 3, an apparatus at least including a pattern roll 10, a pressing roll 20, and energy source 30 is provided. The pattern roll 10 and the pressing roll 20 are leant against with each other. A substrate 110 is placed between the pattern roll 10 and the pressing roll 20 and the substrate 110 can be transmitted in the predetermined direction D. Herein, the energy source 30 is located at the downstream of the pattern roll 10 in the predetermined direction D.

During performing the embossing process, a rapid-cured material 120′ is applied on the substrate 110 at the upstream of the pattern roll 10 in the predetermined direction D. The rapid-cured material 120′ on the substrate 110 can be squeezed by the pattern roll 10 and the pressing roll 20 when the substrate 110 is transmitted in the direction D. In addition, the rapid-cured material 120′ can be cured immediately by the energy source 30 after squeezing of the pattern roll 10 and the pressing roll 20 and the cured rapid-cured material 120′ can be separated from the pattern roll 10 to form the decoration film 100 including the relief pattern layer 120 formed on the substrate 110 as shown in FIG. 1 and FIG. 2.

It is noted that the surface of the pattern roll 10 can have a predetermined concave-convex structure 12 thereon and thus the relief pattern layer 120 can have a relief surface 122. Specifically, the relief surface 122 is configured away from the substrate 110 and the relief pattern layer 120 includes a decoration relief portion 126 and a marker relief portion 124 located around the decoration relief portion 126.

In the present embodiment, the substrate 110 can be a flexible substrate and a material of the substrate 110 can be polyethylene terephthalate (PET), polyethylene naphthalate (PEN), polyethylene glycol-co-cyclohexane-1,4 dimethanol terephthalate (PETG), thermalplastic polyurethane (TPU), polyurethane (PU), polypropylene (PP), polycarbonate (PC), amorphous polyethylene terephthalate (A-PET), polyvinyl chloride (PVC), Polystyrene (PS), triacetyl cellulose (TAC), polymethylmethacrylate (PMMA), methylmethacrylate-styrene (MMA-st, MS) copolymer, cyclo olefin copolymer (COC) and a combination thereof, but the invention is not restricted herein.

In addition, a material of the rapid-cured material 120′ can include a UV-curable gum suitable for being cured immediately during the embossing process. Therefore, the energy source 30 according to the present embodiment can be a UV source. Certainly, the rapid-cured material 120′ can be other materials capable of being cured immediately during the embossing process. In one example, the rapid-cured material 120′ can be a thermal curable material and the energy source 30 can be correspondingly a heater. In addition, the material of the relief pattern layer 120 can further includes a dye, a pigment, a filler, or a combination thereof such that the relief pattern layer 120 can represent certain color. In an example, the pigment can be carbon black, titanium white, or the like and the filler can include the materials such as CaCO₃, ZnO, Al₂O₃, BaSO₄, or the like. When the marker relief portion 124 provides the position alignment function in the subsequent process, the colored marker relief portion 124 can be detected easily. However, the invention is not restricted thereto and the relief pattern layer 120 can be colorless when the marker relief portion 124 has suitable dimension for detecting by the position alignment apparatus. For example, the relief depth of the marker relief portion 124 in the relief pattern layer 120 can be designed according to the detecting limitation of the position alignment apparatus and can be from 3 μm to 25 μm in an exemplary example.

It is noted that other function layers or decoration layers can be further formed on the substrate 110 and the decoration film 100 can be used in an IMD process for forming a decoration device. The following descriptions provide several designs of the decoration film and several decoration device fabricated thereby according to the present invention for clearly pointing out the scope of the invention, but it should be noted that the following descriptions are not intent to be construe as a limitation of the invention.

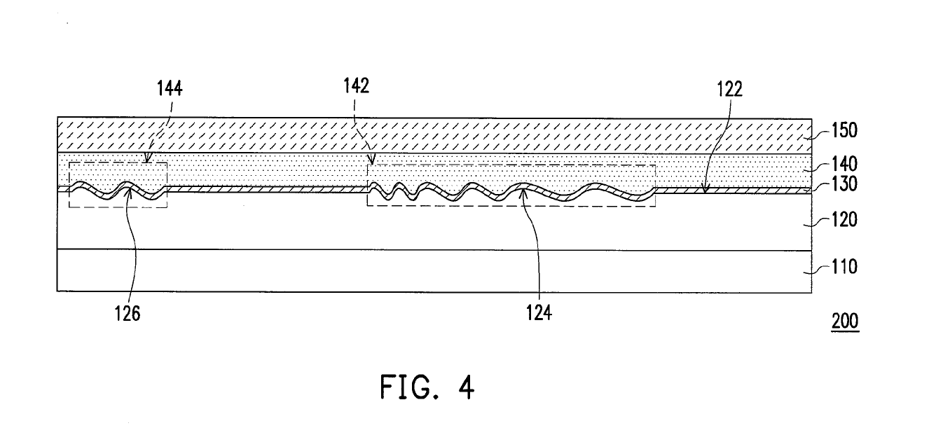

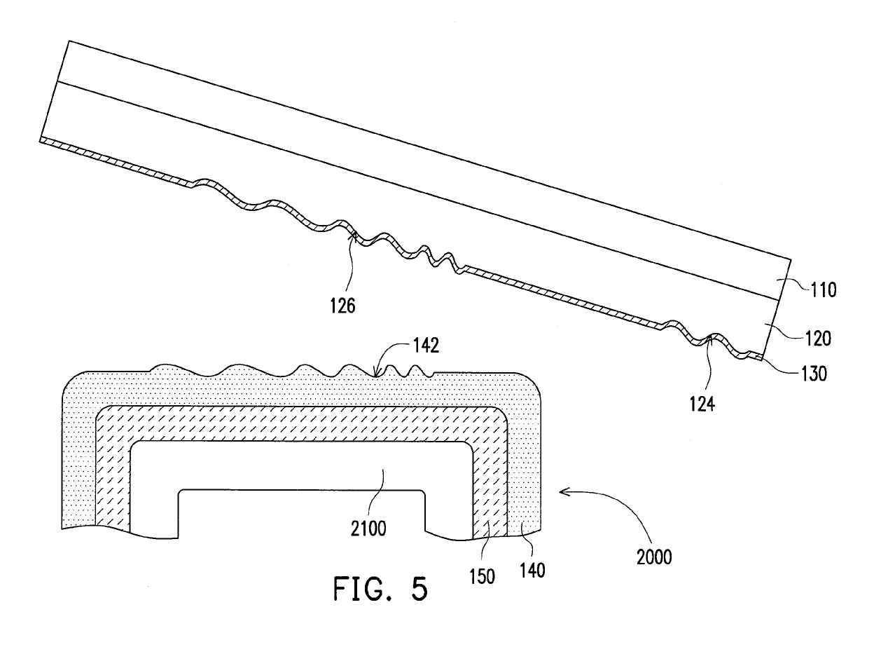

FIG. 4 schematically illustrates a decoration film according to a first embodiment of the present invention. Referring to FIG. 4, the decoration film 200 includes the substrate 110 and the relief pattern layer 120 and further includes a releasing layer 130, a hard coat layer 140, and an adhesion layer 150. The substrate 110 and the relief pattern layer 120 is similar to those described in FIG. 2 and FIG. 3 and the relief pattern layer 120 can be fabricated by the method depicted in FIG. 1. In the present embodiment, the releasing layer 130, the hard coat layer 140, and the adhesion layer 150 can be sequentially formed on the relief surface 122 of the relief pattern layer 120. The releasing layer 130 can be conformed to the relief surface 122. In addition, the hard coat layer 140 has a decoration relief 142 and a marker relief 144 respectively corresponding to the decoration relief portion 124 and the marker relief portion 126.

FIG. 5 schematically illustrates a decoration device fabricated by using the decoration film of FIG. 4 according to the first embodiment of the present invention. Referring to FIG. 4 and FIG. 5, the decoration film 200 as shown in FIG. 4 is adhered on a body 2100 and thereafter, the substrate 110 is separated from the body 2100 to form a decoration device 2000, wherein the relief pattern layer 120 and the releasing layer 130 are remained on the substrate 100 when the substrate 100 is separated from the body 110.

In the present embodiment, the method for adhering the decoration film 100 on the body 2100 includes the IMD process or any decoration process mentioned in above. Specifically, when the body 2100 is formed by an in-mold ejection process, the decoration film 100 can be adhered on the body 2100 by performing the in-mold decoration process and the body 2100 can be made of plastic material. Alternately, when the body 2100 is formed by a punching process of a metal piece, the decoration film 100 can be adhered on the body 2100 during the punching process and the body 2100 can be made of metal. The decoration relief 142 and the marker relief 144 are substantially conformed to the decoration relief portion 124 and the marker relief portion 126, respectively. Accordingly, the hard coat layer 140 has a rough surface away from the adhesion layer 150 corresponding to the relief surface 122 of the relief pattern layer 120. The rough surface of the hard coat layer 140 is exposed after the substrate 110 and the relief pattern layer 120 formed thereon are separated from the body 2100.

It is noted that the decoration relief 142 is located at a part of the outer surface of the hard coat layer 140 so as to provide specific roughness touching feeling at certain location for a user. It may be requested that the location of the decoration relief 142 is well-aligned to other pattern or structures of the decoration device 2000 for satisfying the design purpose. In the present embodiment, the marker relief portion 126 of the relief pattern layer 120 can provide the position alignment function so that the alignment of the decoration relief 142 can be desirable, which is conducive to improve the quality of the decoration device 2000.

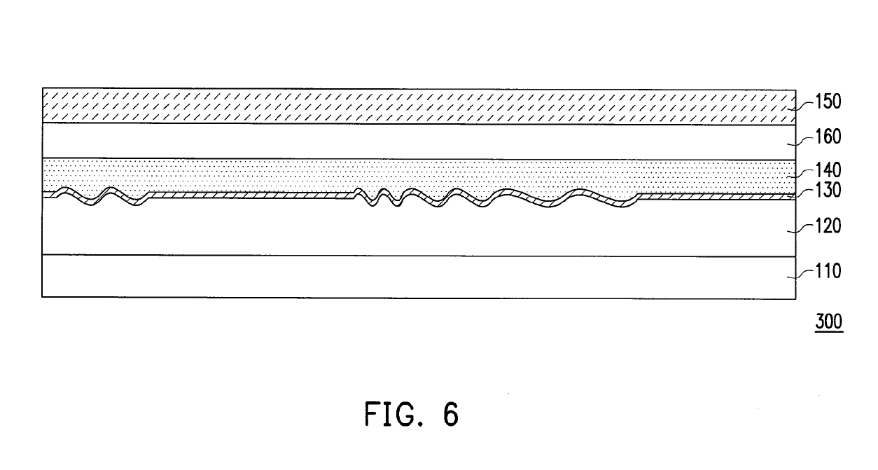

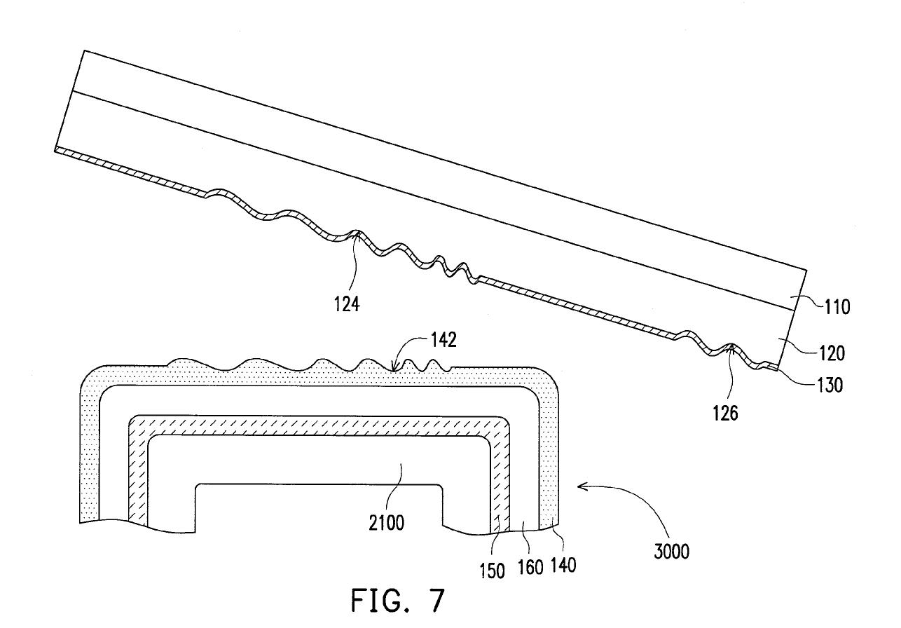

FIG. 6 schematically illustrates a decoration film according to a second embodiment of the present invention and FIG. 7 schematically illustrates a decoration device fabricated by using the decoration film of FIG. 6 according to the second embodiment of the present invention. Referring to FIG. 6 and FIG. 7, the present embodiment is substantially similar to the first embodiment and thus the identical components are referred to identical reference numbers. Specifically, the difference between the present embodiment and the first embodiment lies in that the decoration film 300 of the present embodiment further includes a function layer 160 disposed between the hard coat layer 140 and the adhesion layer 150, wherein the function layer 160 can include an ink layer, a metal layer, or a combination thereof. Accordingly, in addition to the roughness touch feeling, the decoration device 3000 fabricated by the decoration film 300 can further provide certain vision effect. For example, the function layer 160 can present a specific pattern such as an icon, a trademark, a pattern, and the like on the decoration device 3000.

It is noted that the specific function provided by the function layer 160 may be required to corresponds to the location having the roughness touching feeling. Therefore, the function layer 160 and the hard coat layer 140 must be well-aligned to each other. In the present embodiment, the configuration of the marker relief portion 126 provides the alignment reference to the function layer 160, which is conducive to render the decoration device 3000 having desirable quality.

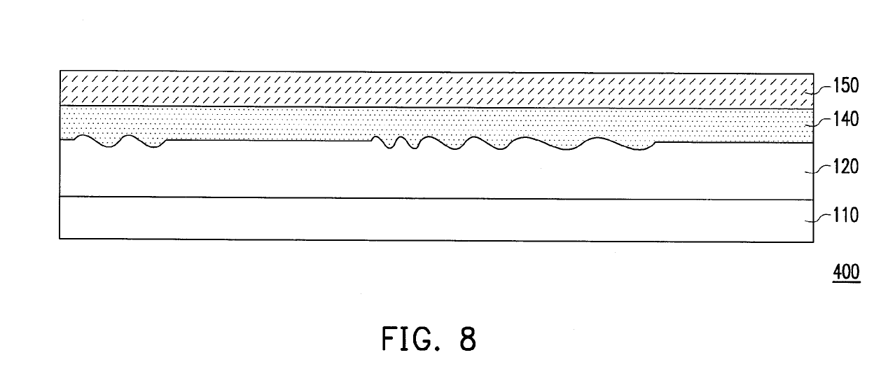

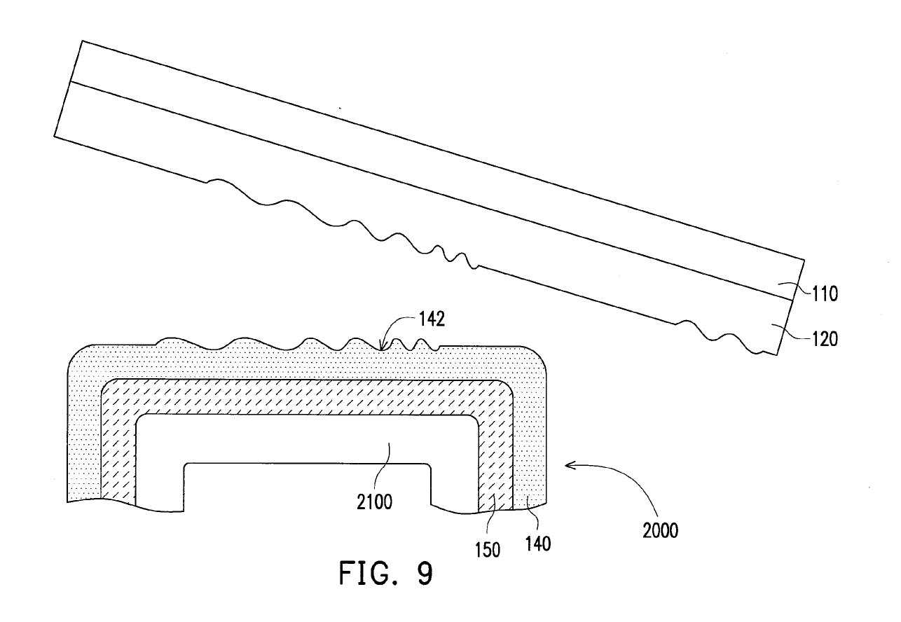

FIG. 8 schematically illustrates a decoration film according to a third embodiment of the present invention and FIG. 9 schematically illustrates a decoration device fabricated by using the decoration film of FIG. 8 according to the third embodiment of the present invention. Referring to FIG. 8 and FIG. 9, the present embodiment is substantially similar to the first embodiment and thus the identical components are referred to identical reference numbers. Specifically, the difference between the present embodiment and the first embodiment lies in that the decoration film 400 does not include the releasing layer 120 as shown in FIG. 4. Accordingly, the hard coat layer 140 can directly contact the relief pattern layer 120 in the present embodiment.

It is noted that the hard coat layer 140 can have the releasing function for applying in the decoration process. Specifically, the substrate 110 and the relief pattern layer 120 of the decoration film 400 must be separated from the body 2100 of the decoration device 2000 such that the hard coat layer 140 can be exposed to provide the roughness touching feeling. Accordingly, the hard coat layer 140 in contact with the relief pattern layer 120 preferably has the releasing function. In an example, the hard coat layer 140 can be fabricated by a material having better adhesion property with the adhesion layer 150 than with the relief pattern layer 120 and such material can include silicon acrylate, fluoro acrylate, or some of additives having release property.

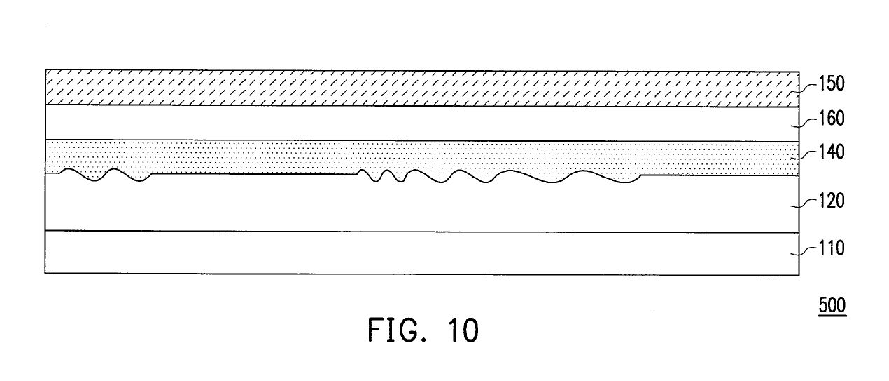

FIG. 10 schematically illustrates a decoration film according to a fourth embodiment of the present invention. Referring to FIG. 10, the decoration film 500 in the present embodiment is substantially similar to that in the third embodiment and thus the identical components are referred to identical reference numbers. Specifically, the difference between the present embodiment and the third embodiment lies in that the decoration film 500 can further include a function layer 160 disposed between the adhesion layer 150 and the relief pattern layer 120. Herein, similar to the third embodiment, the hard coat layer 140 can have the releasing function such that the decoration film 500 can be configured without a releasing layer as shown in FIG. 6, which is conducive to simplify the fabricating the decoration film 500 and reduce the fabrication cost.

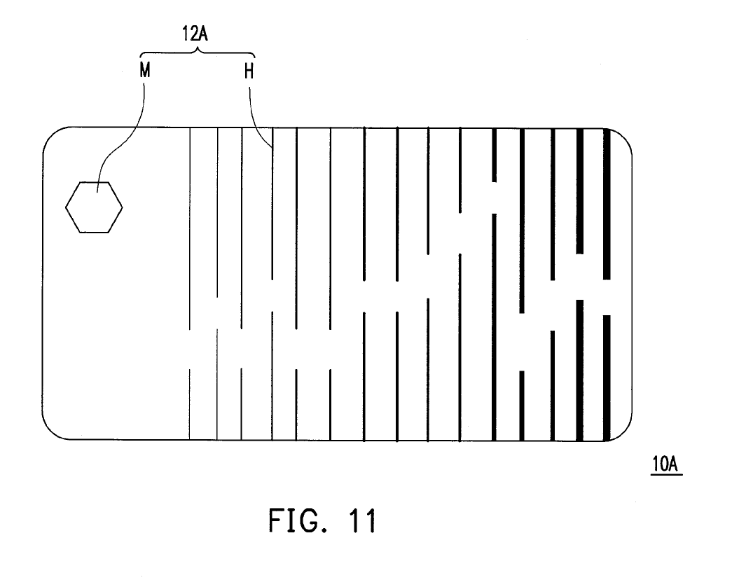

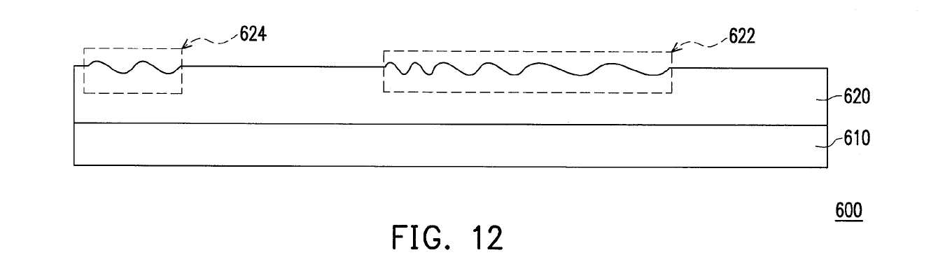

In the foregoing embodiments, the outline of the decoration relief portion 126 on the relief pattern layer 120 can be determined by the concave-convex structure 12 of the pattern roll 10 depicted in FIG. 1. In the first embodiment as shown in FIG. 2, the outline of the decoration relief portion 126 is an irregular pattern such as a cloud, but the invention is not limited thereto. In an alternate embodiment, the design of the concave-convex structure 10 of the pattern roll 10 can have regular patterns. For example, FIG. 11 schematically illustrates a pattern roll using in the embossing process according to another embodiment of the invention and FIG. 12 schematically illustrates a decoration film fabricated by the pattern roll of FIG. 11. Referring to FIG. 11 and FIG. 12, a pattern roll 10A can have a regular concave-convex structure 12A. It is noted that the concave-convex structure 12A includes a marker point M and a plurality of linear traces H having gradually increasing width in a particular direction. When the pattern roll 10A is applied in fabricating a decoration film by using the method depict in FIG. 1, a decoration film 600 shown in FIG. 12 can be formed. The decoration film 600 includes the substrate 610 and the relief pattern layer 620, wherein the relief pattern layer 620 includes a decoration relief potion 622 and a marker relief portion 624 corresponding to the hairline traces H and the marker point M of the pattern roll 10A, respectively.

When the decoration film 600 is applied in fabricating a decoration device, the decoration device can have hairline relief on the hard coat layer. Accordingly, the roughness touching feeling can correspond to the hairline distribution. When compared to the recent design of the decoration device which merely have the hairline vision effect, the design of the present embodiment can further provide the hairline touching feeling, which improves the variety of the design of the decoration device.

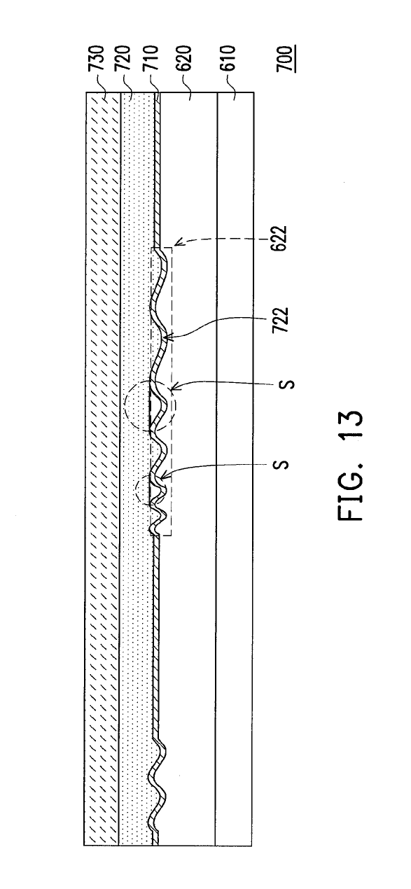

It is noted that the hairline relief on the decoration device is usually determined by the concave-convex structure 12A of the pattern roll 10A. However, in certain circumstances, the designer may want to modify the distribution of the hairline relief on the decoration device. As such, the designer may need to buy or fabricate a new pattern roll, which is time consumption and cost increasing. Therefore, a decoration film fabricated by using the pattern roll 10A is provided in FIG. 13, wherein a new pattern roller is not required for modifying the distribution of the hairline relief on the decoration device made by the decoration film.

Referring to FIG. 13, a decoration film 700 includes the substrate 610 and the relief pattern layer 620 depicted in FIG. 12 and further includes a releasing layer 710, a hard coat layer 720, and an adhesion layer 730. In the present embodiment, the relief pattern layer 620 is fabricated by using the pattern roll 10A depicted in FIG. 11 and thus the relief pattern layer 620 can construct the hairlines in top view vision (not shown).

In the present embodiment, a portion of the hairlines of the relief pattern layer 620 may not be required to form in the end product according particular design and thus the method of fabricating the decoration film 700 can include applying a hard coat material on the relief pattern layer 620; adjusting an amount of the hard coat material on the relief pattern layer 620 such that a space S can be defined between the hard coat material and a part of the decoration relief portion 622; and curing the hard coat material such that the decoration relief 722 of the hard coat layer 720 is substantially conformed to the other part of the decoration relief portion 622. That is to say, a part of the concaves defined by the decoration relief portion 622 of the relief pattern layer 620 is not completely filled by the hard coat material so that the pattern of the decoration relief portion 622 is not completely transformed onto the hard coat layer 720. A decoration device made by the decoration film 700 can have the hairline roughness which is not completely the same to the hairline traces H of the pattern roll 10A, which satisfies the requirement of the designer without increase the fabrication cost.

In view of the above, the decoration film according to the present invention can have the relief pattern layer for fabricating the decoration device with roughness touching feeling and the relief pattern layer has the design for alignment. Accordingly, the relief structure and other patterns in the decoration film can be well-aligned to each other, which is conducive to improve the quality of the decoration device made by the decoration film. Furthermore, the relief structure on the decoration device fabricated by using the decoration film of the present embodiment can be modified through adjusting the hard coat material and can be different from the relief pattern layer of the decoration film, which provides better variety of the design of the decoration device.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A decoration film for decoration process comprising:
a substrate; and
a relief pattern layer disposed on the substrate, the relief pattern layer having a relief surface away from the substrate and comprising a decoration relief portion and a marker relief portion, and the marker relief portion being located around the decoration relief portion, wherein the relief pattern layer is remained on the substrate after the decoration process.

2. The decoration film according to claim 1, wherein a material of the relief pattern layer comprises a rapid-cured material.

3. The decoration film according to claim 2, wherein the rapid-cured material comprises a UV-curable gum suitable for being cured immediately during an embossing process.

4. The decoration film according to claim 2, wherein the material of the relief pattern layer further comprises a dye, a pigment, a filler, or a combination thereof.

5. The decoration film according to claim 1, further comprising a hard coat layer disposed on the relief surface of the relief pattern layer, wherein the hard coat layer has a decoration relief and a marker relief respectively corresponding to the decoration relief portion and the marker relief portion.

6. The decoration film according to claim 5, wherein the decoration relief and the marker relief are substantially conformed to the decoration relief portion and the marker relief portion, respectively.

7. The decoration film according to claim 5, wherein a space is defined between the hard coat layer and a part of the decoration relief portion such that the decoration relief is substantially conformed to the other part of the decoration relief portion.

8. The decoration film according to claim 5, further comprising an adhesion layer disposed on the hard coat layer away from the relief pattern layer.

9. The decoration film according to claim 8, further comprising a function layer disposed between the hard coat layer and the adhesion layer.

10. The decoration film according to claim 9, wherein the function layer comprises an ink layer, a metal layer, or a combination thereof.

11. The decoration film according to claim 5, further comprising a releasing layer disposed between the hard coat layer and the relief pattern layer.

12. The decoration film according to claim 1, wherein a relief depth of the marker relief portion in the relief pattern layer is from 3 μm to 25 μm.

13. A method for fabricating a decoration film comprising:
apply a rapid-cured material on a substrate; and
performing an embossing process on the rapid-cured material and immediately curing the rapid-cured material to form a relief pattern layer having a relief surface away from the substrate, wherein the relief pattern layer comprises a decoration relief portion and a marker relief portion located around the decoration relief portion.

14. The method for fabricating a decoration film according to claim 13, wherein the rapid-cured material comprises a UV-curable gum.

15. The method for fabricating a decoration film according to claim 13, further comprising forming a hard coat layer on the relief surface of the relief pattern layer, wherein the hard coat layer has a decoration relief and a marker relief respectively corresponding to the decoration relief portion and the marker relief portion.

16. The method for fabricating a decoration film according to claim 15, wherein the decoration relief and the marker relief are substantially conformed to the decoration relief portion and the marker relief portion, respectively.

17. The method for fabricating a decoration film according to claim 15, wherein the method of forming the hard coat layer comprises:
applying a hard coat material on the relief pattern layer;
adjusting an amount of the hard coat material on the relief pattern layer such that a space is defined between the hard coat material and a part of the decoration relief portion; and
curing the hard coat material such that the decoration relief of the hard coat layer is substantially conformed to the other part of the decoration relief portion.

18. The method for fabricating a decoration film according to claim 15, further comprising forming an adhesion layer on the hard coat layer away from the relief pattern layer.

19. The method for fabricating a decoration film according to claim 18, further comprising forming a function layer disposed between the hard coat layer and the adhesion layer.

20. The method for fabricating a decoration film according to claim 19, wherein the function layer comprises an ink layer, a metal layer, or a combination thereof.

21. The method for fabricating a decoration film according to claim 15, further comprising forming a releasing layer disposed between the hard coat layer and the relief pattern layer.

22. A method for fabricating a decoration device, comprising:
providing a decoration film, the decoration film comprising:
a substrate;
a relief pattern layer disposed on the substrate, the relief pattern layer having a relief surface away from the substrate and comprising a decoration relief portion and a marker relief portion, and the marker relief portion being located around the decoration relief portion;
a hard coat layer disposed on the relief surface of the relief pattern layer, wherein the hard coat layer has a decoration relief and a marker relief respectively corresponding to the decoration relief portion and the marker relief portion; and
an adhesion layer disposed on the hard coat layer away from the relief pattern layer;
adhering the decoration film on a body and subsequently removing the substrate and the relief pattern layer from the body to form a decoration device, wherein the relief pattern layer is remained on the substrate and the hard coat layer is exposed.

23. The method for fabricating a decoration device according to claim 22, wherein the method of adhering the decoration film on the body comprises an in-mold decoration process.

24. The method for fabricating a decoration device according to claim 22, wherein the decoration film further comprises a releasing layer between the hard coat layer and the relief pattern layer, and the releasing is further removed during removing the substrate and the relief pattern layer from the body.
